(19) United States
(12) Patent Application Publication
(10) Pub. No.: US 2016/0255239 A1
(43) Pub. Date: Sep. 1, 2016

(54) Image Processing Apparatus and Image Processing Method

(71) Applicant: KYOCERA DOCUMENT SOLUTIONS INC., Osaka-shi, Osaka (JP)

(72) Inventor: Keisaku Matsumae, Osaka (JP)

(21) Appl. No.: 15/033,582

(22) PCT Filed: Oct. 29, 2014
(86) PCT No.: PCT/JP2014/078706

§ 371 Date: Apr. 29, 2016

(30) Foreign Application Priority Data
Oct. 31, 2013 (JP) 2013-226853

(51) Int. Cl. H04N 1/393; H04N 1/387; H04N 1/04

(52) U.S. Cl. CPC H04N 1/393; H04N 1/0443; H04N 1/3876; H04N 2201/0094

(57) ABSTRACT

An image processing apparatus includes an image acquiring portion, a first determination portion, a second determination portion, a third determination portion, and an image dividing portion. The image acquiring portion acquires an image. The first determination portion determines whether a drawing is present in a band-like region including a center in the direction of a long side or a short side of the image. The second determination portion determines whether there is drawing continuity between images in respective image regions located at both sides of the band-like region. The third determination portion determines whether the acquired image is an aggregate image formed by aggregating images of a plurality of pages, on the basis of the determination results of the first and second determination portions. The image dividing portion divides the acquired image when the acquired image is determined to be an aggregate image by the third determination portion.

### TECHNICAL FIELD

The present invention relates to an image processing apparatus such as a multifunction peripheral or a scanner, and more particularly to a technology of an image process for dividing an aggregate image formed by aggregating images of a plurality of pages into the images of the respective pages before aggregation.

### BACKGROUND ART

Patent Literature 1 described below discloses an image processing apparatus in which it is determined whether or not an image to be printed is an aggregate image formed by aggregating images of a plurality of pages in one page, and when the image to be printed is determined to be an aggregate image, the aggregate image is divided into the images of the respective pages before aggregation and each of the divided images is printed.

Specifically, the image division apparatus disclosed in Patent Literature 1 extracts a region (hereinafter referred to as an “image check band”) having a predetermined pixel width, with a centerline in the direction of a long side or the direction of a short side of an image being defined as a center. In the case where a drawing is not present in the image check band, this apparatus determines that the image is an aggregate image and divides the image, and in the case where a drawing is present, the apparatus determines that the image is not an aggregate image and does not divide the image.

### CITATION LIST

### Patent Literature

[PTL 1] Japanese Laid-Open Patent Publication No. 2002-215380

### SUMMARY OF THE INVENTION

### Problems to be Solved by the Invention

However, there is a case where the image should not be divided even if a drawing is not present in the image check band. For example, there is a case where drawings at both sides of the image check band have continuity, such as a case where an image of one word composed of a plurality of letters is formed across the both sides of the image check band. It is highly likely that such an image is not an aggregate image. However, with the technology in Patent Literature 1, in the case where a drawing is not present in the image check band, the image is divided regardless of the conditions of drawings in regions other than the image check band. Therefore, the image is divided even if there is continuity of drawings as described above.

Further, there is a case where an aggregate image includes, in the image check band, a boundary image, such as a solid line or a dotted line, indicating a boundary of an image in each page before the aggregation. When an image to be printed has such a boundary image, since the image to be printed is an aggregate image, it is preferable that the image is divided into the images of the respective pages before the aggregation. However, according to the technology in Patent Literature 1, the image is not divided because a drawing is present in the image check band.

The present invention has been made in view of the above problem, and an object of the present invention is to provide an image processing apparatus and an image processing method capable of enhancing precision in determining whether image division is needed or not.

### Solution to the Problems

An image processing apparatus according to one aspect of the present invention includes an image acquiring portion, a first determination portion, a second determination portion, a third determination portion, and an image dividing portion. The image acquiring portion acquires an image. The first determination portion determines whether or not a drawing is present in a band-like region with a predetermined width including a center in the direction of a long side or in the direction of a short side of the image acquired by the image acquiring portion. The second determination portion determines whether or not there is drawing continuity between images in respective image regions located at both sides of the band-like region. The third determination portion determines whether or not the acquired image is an aggregate image formed by aggregating images of a plurality of pages, on the basis of the determination result of the first determination portion and the determination result of the second determination portion. The image dividing portion divides the acquired image, when the acquired image is determined to be an aggregate image by the third determination portion.

An image processing method according to another aspect of the present invention includes a first step, a second step, a third step, a fourth step, and a fifth step. In the first step, an image is acquired. In the second step, it is detected whether or not a drawing is present in a band-like region with a predetermined width including a center in the direction of a long side or in the direction of a short side of the image acquired in the first step. In the third step, it is determined whether or not there is drawing continuity between images in respective image regions located at both sides of the band-like region. In the fourth step, it is determined whether or not the acquired image is an aggregate image formed by aggregating images of a plurality of pages, on the basis of the determination result in the second step and the determination result in the third step. In the fifth step, the acquired image is divided, when the acquired image is determined to be an aggregate image in the fourth step.

### Advantageous Effects of the Invention

According to the present invention, precision in determining whether image division is needed or not can be enhanced.

### BRIEF DESCRIPTION OF THE DRAWINGS

FIG. 1 is a schematic view illustrating an internal configuration of an image processing apparatus according to one embodiment of the present invention.

FIG. 2 is a block diagram illustrating one example of an electric configuration of the image processing apparatus.

FIG. 3 is an explanatory view for a band-like region.

FIG. 4A is a view illustrating an image example of an acquired image.

FIG. 4B is a view illustrating an image example of an acquired image.

FIG. 4C is a view illustrating an image example of an acquired image.

FIG. 4D is a view illustrating an image example of an acquired image.

FIG. 4E is a view illustrating an image example of an acquired image.

FIG. 4F is a view illustrating an image example of an acquired image.

FIG. 4G is a view illustrating an image example of an acquired image.

FIG. 4H is a view illustrating an image example of an acquired image.

FIG. 5 is an explanatory view of an image size adjustment process to a divided image.

FIG. 6 is a flowchart illustrating an image dividing process executed by a control portion.

### DESCRIPTION OF EMBODIMENT

An embodiment of the present invention will be described below with reference to the drawings. Note that the embodiment described below is only an example embodying the present invention, and does not limit the technical scope of the present invention.

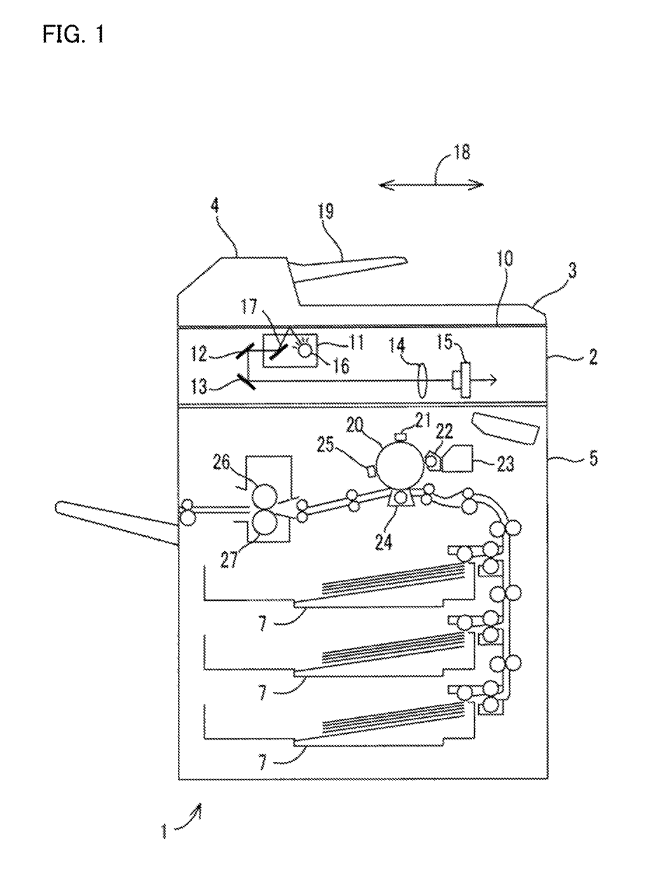

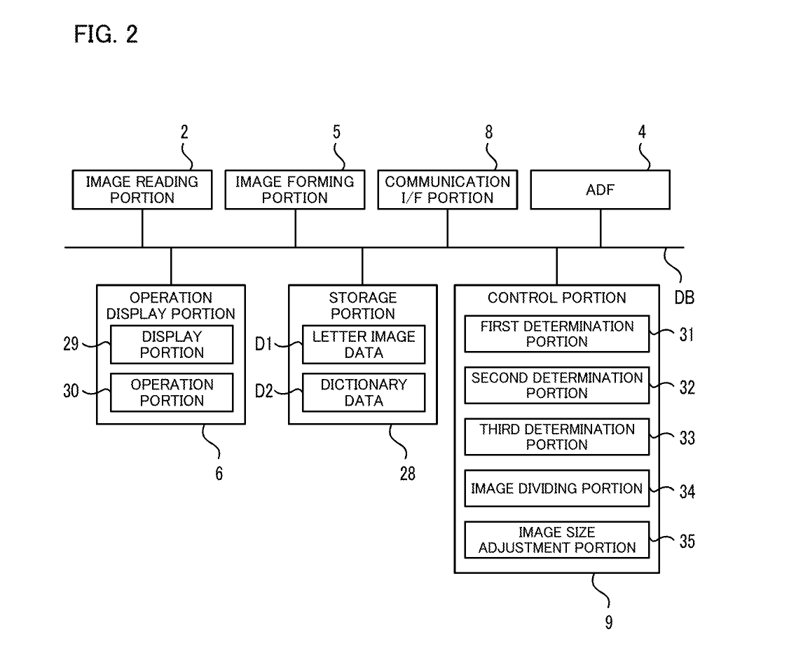

Firstly, a schematic configuration of an image processing apparatus 1 according to the embodiment of the present invention will be described with reference to FIGS. 1 and 2. The image processing apparatus 1 is a multifunction peripheral having an image reading function, a facsimile function, an image forming function, and the like. As illustrated in FIG. 1, the image processing apparatus 1 includes an image reading portion 2, a document cover 3, an auto document feeder (hereinafter referred to as an ADF) 4, an image forming portion 5, an operation display portion 6 (see FIG. 2), a sheet feed cassette 7, a communication interface (I/F) portion 8 (see FIG. 2), and a control portion 9 (see FIG. 2) controlling these components. Notably, while the image processing apparatus 1 that is a multifunction peripheral is described as one example of an image processing apparatus according to the present invention, the present invention is not limited thereto, and a printer, a facsimile device, a copying machine, or a scanner device also corresponds to the image processing apparatus according to the present invention.

The image reading portion 2 is one example of an image acquiring portion, and executes an image reading process for reading image data from a document. As illustrated in FIG. 1, the image reading portion 2 includes a contact glass 10, a reading unit 11, mirrors 12 and 13, an optical lens 14, a CCD (Charge Coupled Device) 15, and the like.

The reading unit 11 includes an LED light source 16 and a mirror 17, and is configured to be movable in a sub-scanning direction 18 (in the horizontal direction in FIG. 1) with a moving mechanism (not illustrated) using a drive motor such as a stepping motor or the like. When the reading unit 11 is moved in the sub-scanning direction 18 with the drive motor, light emitted from the LED light source 16 toward the contact glass 10 provided on the top surface of the image reading portion 2 scans in the sub-scanning direction 18.

When light is emitted from the LED light source 16, the mirror 17 reflects reflection light, which is reflected on the document or the back surface of the document cover 3, toward the mirror 12,. The light reflected on the mirror 17 is guided to the optical lens 14 by the mirrors 12 and 13. The optical lens 14 condenses the incident light and causes the resultant light to be incident on the CCD 15.

The CCD 15 is a photoelectric conversion element that converts the received light into an electric signal (voltage) according to the quantity (intensity of brightness) of the received light and outputs the electric signal to the control portion 9. The control portion 9 performs an image process to the electric signal from the CCD 15 to generate image data of the document. It is to be noted that, although the present embodiment describes the example using the CCD 15 as an imaging element, a reading mechanism using a contact image sensor (CIS) having a focal length shorter than the CCD 15 can also be applied in place of the reading mechanism using the CCD 15.

The document cover 3 is pivotably mounted to the image reading portion 2. The contact glass 10 on the top surface of the image reading portion 2 is opened and closed by the document cover 3 being operated to pivot. A cover opening detection sensor (not illustrated) such as a limit switch is provided at a pivoting support portion of the document cover 3, and when a user opens the document cover 3 to cause an image of a document to be read, the cover opening detection sensor is activated, and a detection signal thereof (cover opening detection signal) is output to the control portion 9.

Reading of a document image by the image reading portion 2 is performed in the following procedure. Firstly, a document is placed on the contact glass 10, and then, the document cover 3 is brought into a closed state. When an image reading command is then input from an operation display portion 6, one line of light is sequentially continuously emitted from the LED light source 16, while the image reading unit 11 is moved to the right in the sub-scanning direction 18. Then, reflection light from the document or the back surface the document cover 3 is guided to the CCD 15 through the mirrors 17, 12, and 13 and the optical lens 14, whereby light amount data according to the quantity of light received by the CCD 15 is sequentially output to the control portion 9. When acquiring light amount data in the entire region irradiated with light, the control portion 9 processes the light amount data, thereby generating image data of the document from the light amount data. This image data constitutes a rectangular image.

Notably, the ADF 4 is mounted to the document cover 3. The ADF 4 conveys one or more documents set on a document set portion 19 one by one with a plurality of conveyance rollers, and moves the document to pass through an automatic document reading position, which is defined on the contact glass 10, to the right in the sub-scanning direction 18. When the document is moved by the ADF 4, the reading unit 11 is disposed below the automatic document reading position, and an image of the moving document is read by the reading unit 11 at this position. The document set portion 19 is provided with a mechanical document detection sensor (not illustrated) capable of outputting a contact signal. When a document is set on the document set portion 19, the document detection sensor described above is activated, and the detection signal thereof (document detection signal) is output to the control portion 9.

As illustrated in FIG. 1, the image forming portion 5 is an electrophotographic image forming portion that executes an image forming process (printing process) based on image data read by the image reading portion 2 or a print job input through the communication I/F portion 8 from an external information processing apparatus such as a personal computer. Specifically, the image forming portion 5 includes a photosensitive drum 20, a charging portion 21, a developing portion 22, a toner container 23, a transfer roller 24, an electricity removing portion 25, a fixing roller 26, a pressure roller 27, and the like. It is to be noted that, although the present embodiment describes an electrophotographic image forming portion 5 as one example, the image forming portion 5 is not limited to the electrophotographic type, and may be of an ink jet recording type, or other recording type or printing type.

Here, the image forming portion 5 executes the image forming process to a print sheet fed from the sheet feed cassette 7 in the following procedure. Firstly, when a print job including a print command is input through the communication I/F portion 8, the photosensitive drum 20 is uniformly charged to a predetermined potential with the charging portion 21. Next, the surface of the photosensitive drum 20 is irradiated with light based on image data included in the print job by a laser scanner unit (LSU, not illustrated). With this, an electrostatic latent image is formed on the surface of the photosensitive drum 20. The electrostatic latent image on the photosensitive drum 20 is then developed (made visible) as a toner image by the developing portion 22. Notably, toner (developer) is replenished from the toner container 23. Subsequently, the toner image formed on the photosensitive drum 20 is transferred onto a print sheet by the transfer roller 24. Thereafter, the toner image transferred onto the print sheet is heated by the fixing roller 26, and fused and fixed, when the print sheet passes between the fixing roller 26 and the pressure roller 27 and is discharged. Notably, the potential of the photosensitive drum 20 is removed by the electricity removing portion 25.

With reference to FIG. 2, the communication I/F portion 8 is an interface that executes data communication with an external device connected to the image processing apparatus 1 through the Internet or a communication network such as LAN. A storage portion 28 is composed of a non-volatile memory such as a hard disk drive (HDD).

The storage portion 28 preliminarily stores image data D1 of various letters such as hiragana, katakana, and alphabets. The storage portion 28 also preliminarily stores dictionary data D2 collecting words (terms, texts, phrases) composed of letter strings of these various letters. The image data D1 and the dictionary data D2 are used for a later-described image dividing process.

The control portion 9 is configured to include a CPU (Central Processing Unit) and a memory having a ROM (Read Only Memory) and a RAM (Random Access Memory). The CPU is a processor executing various computation processes. The ROM is a non-volatile storage portion that preliminarily stores information such as a control program to cause the CPU to execute various processes. The RAM is a volatile storage portion, and is used as a temporal storage memory (work area) for various processes executed by the CPU. The control portion 9 controls the operation of each portion by executing a program stored in the ROM by the CPU.

The operation display portion 6 includes a display portion 29 and an operation portion 30. The display portion 29 is composed of a color liquid crystal display, for example, and displays various information sets to a user operating the operation display portion 29. The operation portion 30 includes various push button keys disposed to be adjacent to the display portion 29 and a touch panel sensor disposed on a display screen of the display portion 29, and various commands are input thereto by the user of the image processing apparatus 1. It is to be noted that, when the user performs an operation on the operation display portion 6 for performing the image reading operation or the image forming operation, the operation signal is output to the control portion 9 from the operation display portion 6.

In the image processing apparatus 1, the respective components, which are the image reading portion 2, the image forming portion 5, the operation display portion 6, the communication I/F portion 8, the storage portion 28, and the control portion 9, can mutually input and output data through a data bus DB.

Meanwhile, the image processing apparatus 1 according to the present embodiment is provided with an identification function for identifying whether or not an image of a text document, which is to be copied, for example, is an aggregate image formed by aggregating images of a plurality of pages. The image processing apparatus 1 according to the present embodiment is also provided with an image dividing function for, when an image of a document is an aggregate image, dividing the aggregate image into images of the respective pages before the aggregation, and printing the divided images on individual recording sheets. This aspect will be described below in more detail.

With regard to the image dividing function, the control portion 9 functions as a first determination portion 31, a second determination portion 32, a third determination portion 33, an image dividing portion 34, and an image size adjustment portion 35 through execution of a program by the CPU. The first determination portion 31 is one example of a first determination portion, the second determination portion 32 is one example of a second determination portion, the third determination portion 33 is one example of a third determination portion, the image dividing portion 34 is one example of an image dividing portion, and the image size adjustment portion 35 is one example of an image size adjustment potion.

The first determination portion 31 determines whether or not a drawing is present in a predetermined region of an image acquired through the reading operation of the image reading portion 2. The drawing means an image of a line or an image of a letter, for example. The predetermined region is a band-like region 102 (hatched region in FIG. 3) with a predetermined width including a center position C in the direction of a long side 101 of the acquired image 100. The first determination portion 31 determines that a drawing is present when a predetermined number or more of pixels having a pixel value equal to or lower than a predetermined value (density equal to or higher than a certain value) are present in the band-like region 102.

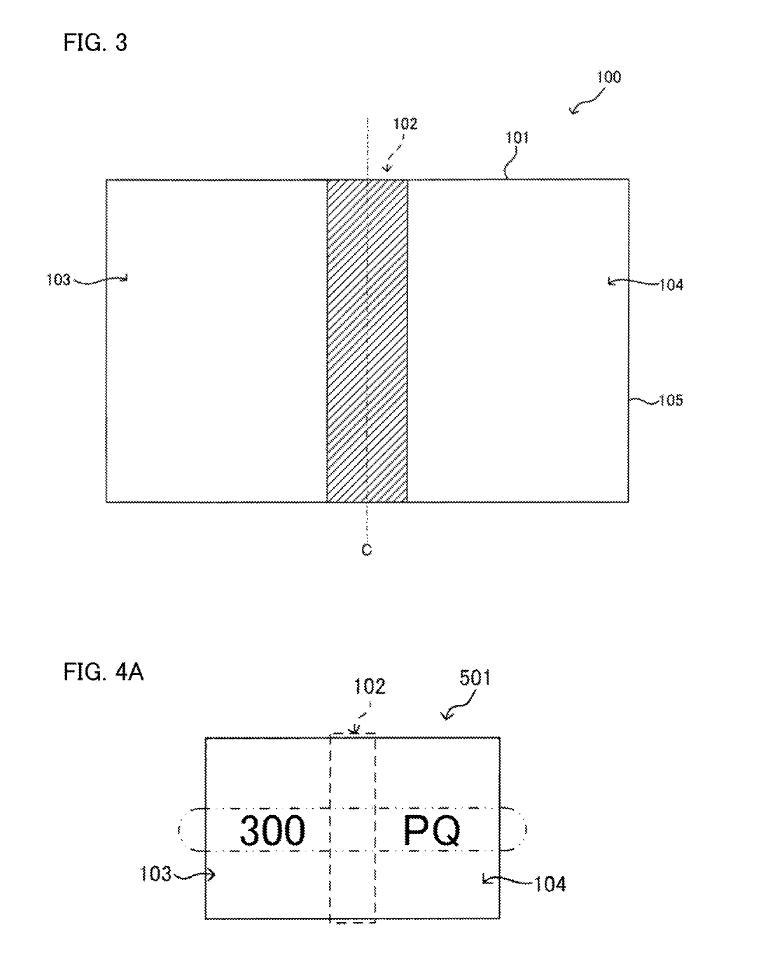

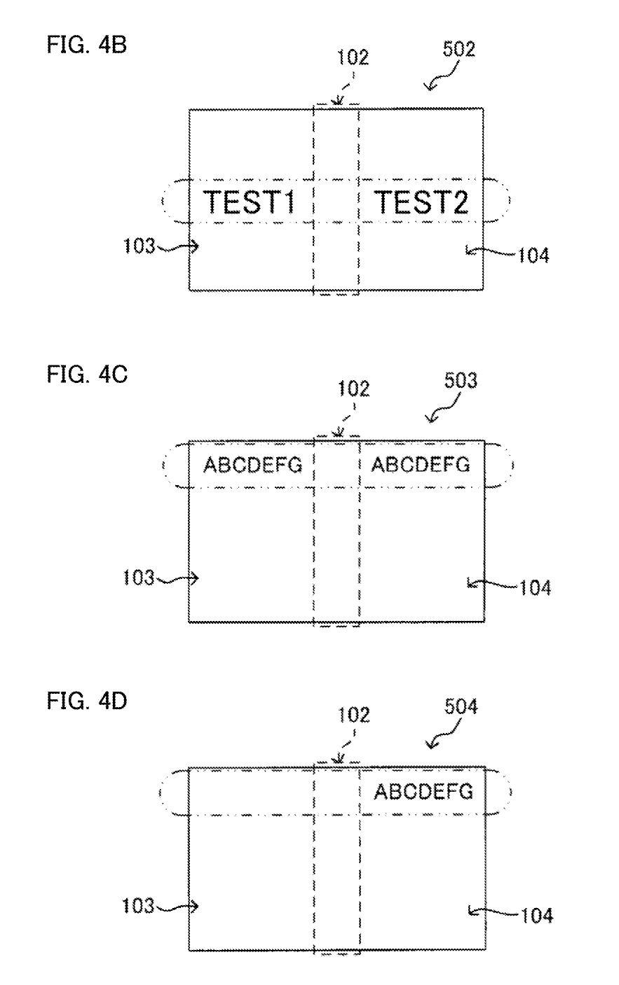

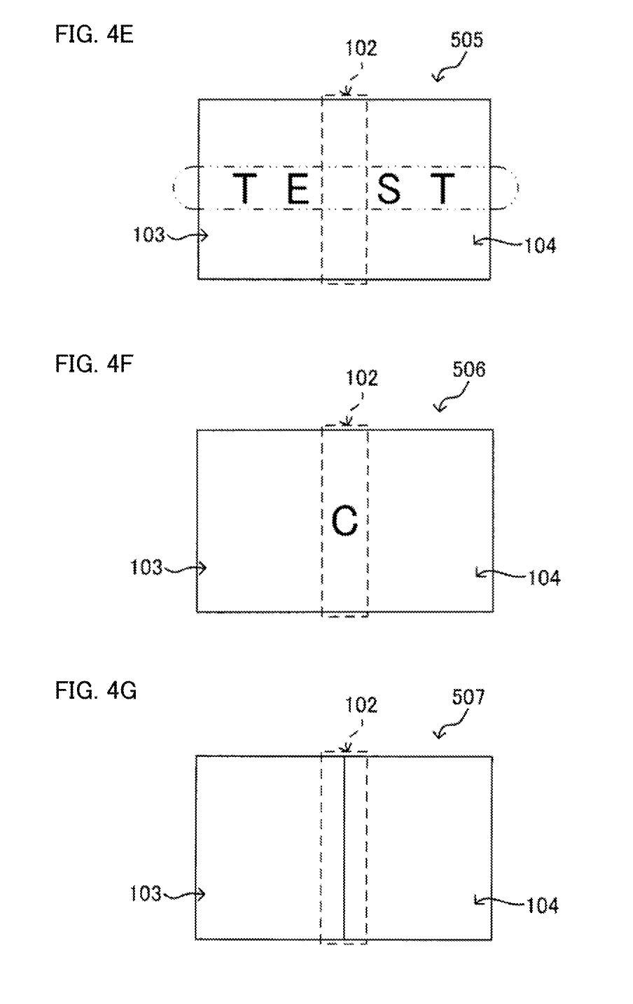

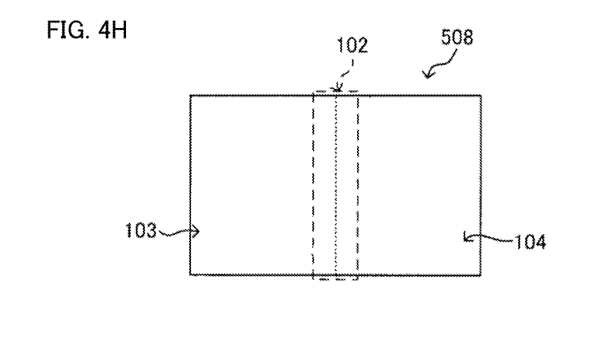

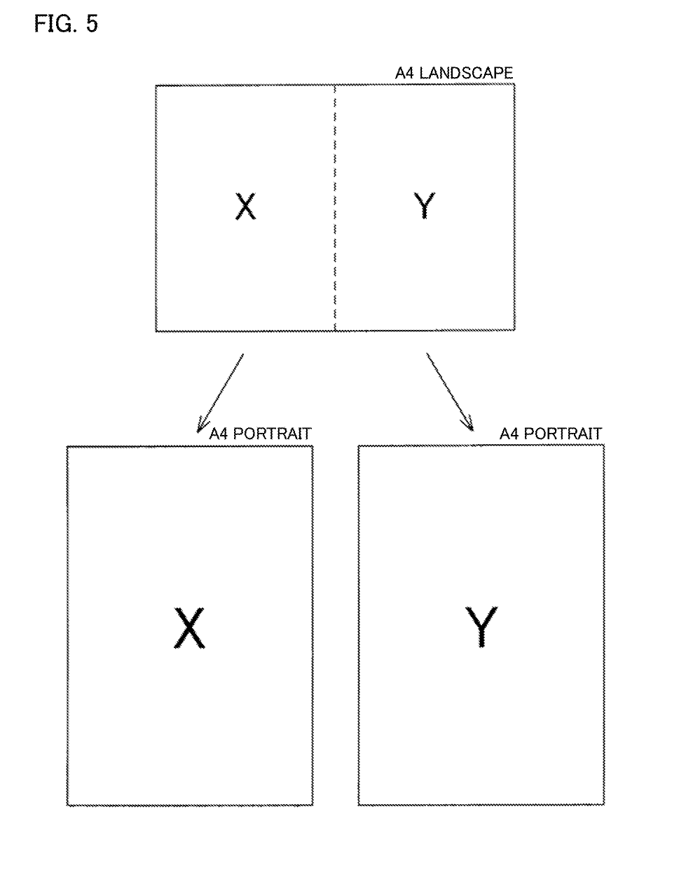

FIGS. 4A to 4H illustrate examples of an acquired image. FIGS. 4A to 4E illustrate one example of acquired images 501 to 505 in which a drawing is not present in the band-like region 102. FIGS. 4F to 4H illustrate one example of acquired images 506 to 508 in which a drawing is present in the band-like region 102.

In the case where the acquired image is any of the acquired images 501 to 505 illustrated in FIGS. 4A to 4E, the first determination portion 31 determines that a drawing is not present in the band-like region 102, based on that image data in the band-like region 102 is uniform white data. On the other hand, in the case where the acquired image is any of the acquired images 506 to 508 illustrated in FIGS. 4F to 4H, the first determination portion 31 determines that a drawing is present in the band-like region 102, based on that image data in the band-like region 102 varies at different parts.

When determining that a drawing is present in the band-like region 102, the first determination portion 31 determines whether or not the drawn image is a boundary line between images in image regions 103 and 104 located at both sides of the band-like region 102. The boundary line is one example of a boundary image, and is a solid line or a dotted line, for example. FIGS. 4G and 4H illustrate the acquired images 507 and 508 in which the drawn image in the band-like region 102 is the boundary line. As illustrated in FIGS. 4G and 4H, the boundary line passes through a center point of each of a pair of long sides 101 of the acquired image, for example. When pixels having a pixel value equal to or lower than a predetermined value are continuously arrayed in a linear fashion, these pixels constitute a straight line. Further, when pixel arrays, each having a plurality of pixels having a pixel value equal to or lower than a predetermined value, are linearly arrayed with a space, these pixels constitute a dotted line. In the case where pixels having a pixel value equal to or lower than a predetermined value are arrayed in the above fashion so as to pass through a center point of each of a pair of long sides 101 in the band-like region 102, the first determination portion 31 determines that the drawn image in the band-like region 102 is a boundary line between images in the image regions 103 and 104.

In the acquired image 506 illustrated in FIG. 4F, the drawn image in the band-like region 102 is not an image of the boundary line but an image of an alphabet “C”.

In the case where the acquired image is the acquired image 506 illustrated in FIG. 4F, the first determination portion 31 determines that the drawn image in the band-like region 102 is not the image of the boundary line. On the other hand, in the case where the acquired image is either of the acquired images 507 and 508 illustrated in FIGS. 4G and 4H, the first determination portion 31 determines that the drawn image in the band-like region 102 is the boundary line.

The second determination portion 32 determines whether or not the acquired image, which has been determined that a drawing is not present in the band-like region 102 by the first determination portion 31, has drawing continuity between the images of letters in the respective image regions 103 and 104 located at both sides of the band-like region 102. The drawing continuity means in the present embodiment that images of letters drawn in the respective image regions 103 and 104 indicate successive letters (a string of letters) composing one word or one phrase (phrase, paragraph).

The process of the second determination portion 32 will be specifically described. Firstly, the second determination portion 32 determines whether or not a drawn image is present in each of the image regions 103 and 104. When determining that a drawn image is present in each of the image regions 103 and 104, the second determination portion 32 detects whether or not the drawn image indicates a letter, and when the drawn image indicates a letter, the second determination portion 32 detects which letter is indicated. As described above, the storage portion 28 preliminarily stores the image data D1 (see FIG. 2) of various letters such as hiragana, and the second determination portion 32 performs the above letter detection by comparing the detected drawn image with the image data D1.

When detecting letters drawn in each of the image regions 103 and 104, the second determination portion 32 determines whether or not there is drawing continuity between the images of the letters in the image regions 103 and 104. That is, the second determination portion 32 determines whether or not the images of letters drawn in the respective image regions 103 and 104 indicate successive letters (a string of letters) composing one word. As described above, the storage portion 28 preliminarily stores the dictionary data D2 (see FIG. 2), and the second determination portion 32 performs the above word detection by comparing the letter string with the dictionary data D2. In the case where the detected letter string is registered as a word in the dictionary data, the second determination portion 32 determines that there is drawing continuity between the images of letters in the image regions 103 and 104. On the other hand, in the case where the detected letter string is not registered as a word in the dictionary data, the second determination portion 32 determines that there is no drawing continuity.

In the acquired image 501 illustrated in FIG. 4A, numeral “300” is formed in the left image region 103, and letters “PQ” are formed in the right image region 104. A string of letters composed of succession of the numeral “300” and the letters “PQ” does not constitute one word or phrase. Therefore, the second determination portion 32 determines that the acquired image 501 illustrated in FIG. 4A does not have drawing continuity.

In the acquired image 502 illustrated in FIG. 4B, letters “TEST1” are formed in the left image region 103, and letters “TEST2” are formed in the right image region 104. Here, a string of letters composed of succession of the letters “TEST1” and the letters “TEST2” does not constitute one word or phrase. Therefore, the second determination portion 32 determines that the acquired image 501 illustrated in FIG. 4B does not have drawing continuity.

In the acquired image 503 illustrated in FIG. 4C, letters “ABCDEFG” are formed in both the left image region 103 and the right image region 104. A case where a company's name, for example, is formed by default setting is conceivable as the above-described case where the same strings of letters are formed in both the left image region 103 and the right image region 104. In the case of the acquired image 503 illustrated in FIG. 4C, a string of letters composed of succession of two sets of letters “ABCDEFG” does not constitute one word or phrase. Therefore, the second determination portion 32 determines that the acquired image 501 illustrated in FIG. 4C does not have drawing continuity.

In the acquired image 504 illustrated in FIG. 4D, letters “ABCDEFG” are formed only in the right image region 104, and nothing is drawn in the left image region 103. In the case where one of the image regions does not have a drawn image as described above, the second determination portion 32 determines that the acquired image does not have drawing continuity. Accordingly, the second determination portion 32 determines that the acquired image 504 illustrated in FIG. 4D does not have drawing continuity.

In the acquired image 505 illustrated in FIG. 4E, letters “TE” are formed in the right image region 104, and letters “ST” are formed in the left image region 103. A string of letters composed of succession of the letters “TE” and the letters “ST” constitutes one word “TEST”. Therefore, the second determination portion 32 determines that the acquired image 505 illustrated in FIG. 4E has drawing continuity.

The third determination portion 33 determines whether or not the acquired image acquired by the reading operation of the image reading portion 2 is an aggregate image, based on the detection result of the first determination portion 31 and the determination result of the second determination portion 32.

Specifically, the third determination portion 33 determines that the acquired image is an aggregate image, in the case where it is not determined by the first determination portion 31 that a drawing is present in the band-like region 102 and it is determined by the second determination portion 32 that there is no drawing continuity between images of letters in the image regions 103 and 104 located at both sides of the band-like region 102. Accordingly, in the case where the acquired image is any of the acquired images 501 to 504 illustrated in FIGS. 4A to 4D, the third determination portion 33 determines that these acquired images 501 to 504 are aggregate images.

On the other hand, the third determination portion 33 determines that the acquired image is not an aggregate image, in the case where it is not determined by the first determination portion 31 that a drawing is present in the band-like region 102 and it is determined by the second determination portion 32 that there is drawing continuity between images of letters in the image regions 103 and 104 located at both sides of the band-like region 102. Accordingly, in the case where the acquired image is the acquired image 505 illustrated in FIG. 4E, the third determination portion 33 determines that this acquired image 505 is not an aggregate image.

In addition, the third determination portion 33 determines that the acquired image is an aggregate image, regardless of the determination result of the second determination portion 32, in the case where a boundary line between images at both sides of the band-like region 102 is detected by the first determination portion 32. Accordingly, in the case where the acquired image is either of the acquired images 507 and 508 illustrated in FIGS. 4G and 4H, the third determination portion 33 determines that these acquired images 507 and 508 are aggregate images.

Further, the third determination portion 33 determines that the acquired image is not an aggregate image, in the case where an image other than the boundary line is detected in the band-like region 102 by the first determination portion 31. Accordingly, in the case where the acquired image is the acquired image 506 illustrated in FIG. 4F, the third determination portion 33 determines that this acquired image 506 is not an aggregate image.

The image dividing portion 34 performs image division to the acquired image that is determined to be an aggregate image by the third determination portion 33. As for the acquired images 501 to 508 illustrated in FIGS. 4A to 4H, the image dividing portion 34 divides each of the acquired images 501 to 504, 507, and 508 illustrated in FIGS. 4A to 4D, 4G, and 4H, which are determined to be aggregate images. The image dividing portion 34 divides each of these acquired images 501 to 504, 507, and 508 into two images at the center in the direction of the long side 101 thereof. However, in the acquired image having the boundary line in the band-like region 102 like the acquired images 507 and 508 illustrated in FIGS. 4G and 4H, if the boundary line is shifted from the center in the direction of the long side 101, the acquired image may be divided at the position of the boundary line. The image dividing portion 34 outputs the image divided in this way to the image size adjustment portion 35.

The image size adjustment portion 35 performs size adjustment for adjusting the image size of the image divided by the image dividing portion 34 to the image size of the image which is not divided. In the present embodiment, the image size adjustment portion 35 adjusts the image size of the image divided by the image dividing portion 34 to the image size of the image which is not divided. For example, in the case where the acquired image is an image formed by reducing two portrait A4-size documents X and Y and aggregating the reduced documents X and Y side by side in the horizontal direction onto an A4 sheet, the image size adjustment portion 35 performs a process for enlarging an image of each of the two documents X and Y included in the aggregate image to the original portrait A4 size which is the image size of the image not divided.

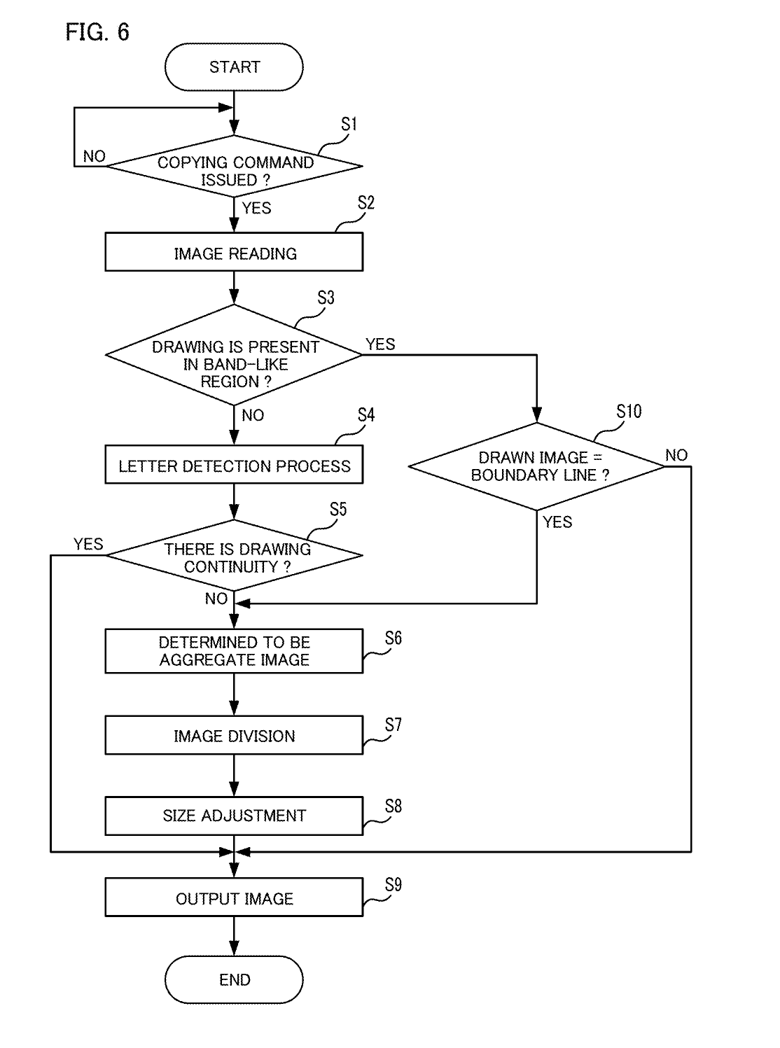

Next, an image dividing process by the control portion 9 will be described. FIG. 6 is a flowchart illustrating the process executed by the control portion 9. When a copy command is issued with a document being set on the document set portion 19, the control portion 9 executes the dividing process for this image. Note that steps S1, S2 . . . , represent the process procedure (step) numbers in the flowchart illustrated in FIG. 6.

When a copying command is issued by a user (YES in step S1), the image reading portion 2 reads an image of the document (step S2). The first determination portion 31 determines whether or not a drawing is present in the band-like region 102 of the image acquired by the image reading portion 2 (step S3).

When the first determination portion 31 consequently determines that a drawing is not present in the band-like region 102 (NO in step S3), the second determination portion 32 performs a process for detecting letters in the image regions 103 and 104 located at both sides of the band-like region 102 (step S4). When the second determination portion 32 detects that an image of a letter is present in each of the image regions 103 and 104, the second determination portion 32 determines whether or not a string of letters composed of succession of these letters constitutes one word, that is, whether or not there is drawing continuity (step S5).

In the case where the second determination portion 32 determines that there is no drawing continuity in step S5 (NO in step S5), the third determination portion 33 determines that the acquired image is an aggregate image, based on the series of determinations (step S6). The image dividing portion 34 divides the acquired image in response to the determination result of the third determination portion 33 (step S7). In addition, the image size adjustment portion 35 performs size adjustment for adjusting the image size of the image divided by the image dividing portion 34 to the image size of the image not divided (step S8). Then, the control portion 9 outputs this image to the image forming portion 5 (step S9).

Further, when determining that a drawing is present in the band-like region 102 in step S3 (YES in step S3), the first determination portion 31 determines whether or not the drawn image is an image of a boundary line (step S10). When the first determination portion 31 consequently determines that the drawn image is an image of a boundary line (YES in step S10), the control portion 9 proceeds to the process in step S6. When the first determination portion 31 determines that the drawn image is not an image of a boundary line (NO in step S10), the control portion 9 proceeds to the process in step S9.

It is to be noted that, when the second determination portion 32 determines that there is drawing continuity in step S5 (YES in step S5), the control portion 9 performs the process in step S9 without performing the processes in steps S6 to S8.

As described above, in the present embodiment, whether image division for an acquired image is needed or not is automatically determined. Accordingly, usability of the image processing apparatus 1 can be enhanced, compared to a configuration in which whether image division is needed or not is manually set.

In addition, in the present embodiment, when there is drawing continuity between images of letters in the image regions 103 and 104 located at both sides of the band-like region 102 even if a drawing is not present in the band-like region 102, the acquired image is determined not to be an aggregate image, and the acquired image is not divided. With the determination described above, in the case where a drawing is not present in the band-like region 102, precision in determining whether image division is needed or not can be enhanced, compared to the conventional technique in which an acquired image is divided regardless of a drawing condition in regions other than the band-like region 102.

Further, in the present embodiment, when a drawing is present in the band-like region 102 of the acquired image and the drawn image is an image of a boundary line, the acquired image is determined to be an aggregate image. With the determination described above as well, precision in determining whether image division is needed or not can be enhanced, compared to the conventional technique.

Since precision in determining whether image division is needed or not can be enhanced, occurrence of a situation in which a printed matter with low visibility is created because a document which is not necessarily divided is divided and output as a printed matter or a situation in which recording sheets are wastefully used can be avoided with a high probability as compared to the conventional technique.

Further, in the present embodiment, the image size of the divided image can be adjusted to the image size of the image not divided. Thus, the image divided by the image dividing portion 34 can be printed and output onto a sheet having the same size as the sheet used for printing the image not divided, with an image size suitable for the size of the sheet.

While the preferable embodiment of the present invention has been described above, the present invention is not limited to the content described above, and various modifications can be made.

In the embodiment described above, the band-like region 102 is defined as a region with a predetermined width including a center in the direction of the long side 101 of the acquired image 100. However, in the case where one acquired image in which images of four documents are aggregated in a matrix array of 2×2 is divided into the images of the four original documents, for example, the acquired image has to be divided not only in the direction of the long side 101 but also in the direction of the short side 105. Considering such a division mode, it is further preferable that a region with a predetermined width including the center in the direction of the short side 105 as well as the region with a predetermined width including the center in the direction of the long side 101 are set as the band-like region 102.

Further, in the embodiment described above, the image size of an image divided by the image dividing portion 34 is adjusted to the image size of an image not divided. On the contrary, the image size of an image not divided may be adjusted to the image size of an image divided by the image dividing portion 34. Notably, in the present embodiment, the image size adjustment described above is not essential, and size adjustment may not be performed.

Moreover, in the embodiment described above, the acquired image is used to be printed and output. However, the acquired image is not limited to be used as described above. For example, the acquired image may be used to be transmitted to other devices, or used to be stored in the image processing apparatus 1.

Further, in the embodiment described above, the image read by the image reading portion 2 is a target image (acquired image) for determination as to whether division is needed or not. However, the configuration is not limited thereto. An image received from other devices may be a target image (acquired image) for determination as to whether division is needed or not. In this case, the communication I/F portion 8 functions as an image acquiring portion.

1. An image processing apparatus comprising:
an image acquiring portion configured to acquire an image;
a first determination portion configured to determine whether or not a drawing is present within a band-like region with a predetermined width including a center in a direction of a long side or in a direction of a short side of the image acquired by the image acquiring portion;
a second determination portion configured to determine whether or not there is drawing continuity between images in respective image regions located at both sides of the band-like region;
a third determination portion configured to determine whether or not the acquired image is an aggregate image formed by aggregating images of a plurality of pages, on the basis of a determination result of the first determination portion and a determination result of the second determination portion; and
an image dividing portion configured to divide the acquired image, when the acquired image is determined to be an aggregate image by the third determination portion, wherein
the third determination portion determines that the acquired image is an aggregate image, when it is not determined by the first determination portion that a drawing is present and it is determined by the second determination portion that there is no drawing continuity.

2. The image processing apparatus according to claim 1, wherein the second determination portion determines whether or not there is drawing continuity between images of letters in the respective image regions located at the both sides of the band-like region.

3. The image processing apparatus according to claim 1, wherein the third determination portion determines that the acquired image is an aggregate image, regardless of the determination result of the second determination portion, when a boundary image indicating a boundary between the images at the both sides of the band-like region is detected by the first determination portion.

4. The image processing apparatus according to claim 1, further comprising an image size adjustment portion configured to adjust an image size of an image divided by the image dividing portion to be the same as an image size of an image which is not divided.

5. An image processing method comprising:
a first step of acquiring an image;
a second step of determining whether or not a drawing is present within a band-like region with a predetermined width including a center in a direction of a long side or in a direction of a short side of the image acquired in the first step;
a third step of determining whether or not there is drawing continuity between images in respective image regions located at both sides of the band-like region;
a fourth step of determining whether or not the acquired image is an aggregate image formed by aggregating images of a plurality of pages, on the basis of a determination result in the second step and a determination result in the third step, and determining that the acquired image is an aggregate image, when it is not determined in the second step that a drawing is present and it is determined in the third step that there is no drawing continuity; and
a fifth step of dividing the acquired image, when the acquired image is determined to be an aggregate image in the fourth step.
